(19) United States
(12) Patent Application Publication
(10) Pub. No.: US 2015/0031797 A1
(43) Pub. Date: Jan. 29, 2015

(54) Room Temperature-Curable Coating Composition

(71) Applicant: Dow Corning Toray Co., Ltd., Tokyo (JP)

(72) Inventors: Satoshi Onodera, Ichihara-shi (JP); Motoshi Sasaki, Ichihara-shi (JP)

(21) Appl. No.: 14/374,554

(22) PCT Filed: Nov. 29, 2012
(86) PCT No.: PCT/JP2012/081593

§ 371 Date: Jul. 25, 2014

(30) Foreign Application Priority Data
Dec. 27, 2011 (JP) 2011-284674

(51) Int. Cl. C09D 183/08; C09D 183/06

(52) U.S. Cl. CPC C09D 183/08; C09D 183/06
USPC 523/400

(57) ABSTRACT

To provide a room temperature-curable coating composition that has superior weatherability, in which cracking over time is suppressed due to by-products not being produced when curing, and the environmental burden is low due to an organic solvent not being included. This invention relates to a room temperature-curable coating composition comprising (A) an epoxy-functional organopolysiloxane and (B) an amino-functional organopolysiloxane.

### TECHNICAL FIELD

The present invention relates to a room temperature-curable coating composition.

### BACKGROUND ART

Conventionally known weather resistant coatings include two-part room temperature drying coatings comprising an epoxy resin as a base compound and a polyamine as a curing agent, and two-part room temperature drying coatings comprising a polyol resin as a base compound and an isocyanate as a curing agent. For example, Japanese Unexamined Patent Application Publication No. 2000-26769 describes a coating composition comprising an organic epoxy resin and an amine curing agent; Japanese Unexamined Patent Application Publication No. 2001-19899 describes a resin coating composition comprising a base compound including a polyol resin and an isocyanate curing agent or a resin coating composition comprising a base compound including an epoxy resin and an amine curing agent; and Japanese Unexamined Patent Application Publication No. 2002-167548 describes a coating composition comprising an epoxy resin and a urethane-amine compound.

Additionally, coating compositions comprising a silicon compound are known. For example, Japanese Unexamined Patent Application Publication No. 2003-64301 describes a coating composition comprising an epoxy resin, an organosilane and/or partial hydrolysate thereof, and an amino group-containing compound; and Japanese Unexamined Patent Application Publication No. 2003-49113 describes a coating composition comprising an epoxy silicone resin and an amino group-containing compound.

However, the base compounds included in these coating compositions all have organic resins as their backbones and, as a result, satisfactory long-term weatherability has not been obtained. Additionally, many coating compositions comprise organic solvents and, therefore, there is a demand for a shift to water-based coating compositions or solvent-free coating compositions from the perspectives of environmental regulations and saving resources.

In response to this demand, Japanese Unexamined Patent Application Publication No. 2009-149791 describes an aqueous coating composition comprising a base component including an epoxy resin emulsion and a pigment and an amine curing agent as a water-based coating composition. However, compared to organic solvent-based coating compositions, the water-based coating compositions have problems such as declines in workability, water resistance of the cured film, corrosion resistance, adhesion to metal materials, and the like. Thus, the composition by which all performances are thoroughly satisfied has not been obtained.

Additionally, development of a coating in which solid content is increased for the purpose of reducing the content of an organic solvent is underway. For example, WO2007/102587 describes a coating composition comprising a base compound including a bisphenol epoxy resin and a curing agent including an epoxy adduct of a xylylenediamine and an epoxy adduct of polyamide. However, a coating composition that is completely free of organic solvents has not been realized. Additionally, while Japanese Unexamined Patent Application Publication No. H09-020878 describes a coating composition comprising a low viscosity aromatic hydrocarbon formaldehyde resin for the purpose of providing a solvent-free coating composition, a coating composition by which long-term weatherability can be satisfied has not been obtained.

Furthermore, Japanese Unexamined Patent Application Publication No. 2011-111490 describes a coating composition comprising a composite resin in which a silicone component is introduced into an organic resin backbone, and Japanese Unexamined Patent Application Publication No. 2011-21157 describes a coating composition comprising a silicon compound of a silane and a siloxane for the purpose of imparting weatherability to a coating composition comprising an organic resin as a base compound. However, a condensation reaction caused by the remaining condensation reacting groups progresses over time, which leads to the problems of cure shrinkage and cracking due to the produced low-boiling components. Therefore, the compounded amount of such components is limited.

### PRIOR ART DOCUMENTS

### Patent Documents

Patent Document 1: Japanese Unexamined Patent Application Publication No. 2000-26769

Patent Document 2: Japanese Unexamined Patent Application Publication No. 2001-19899

Patent Document 3: Japanese Unexamined Patent Application Publication No. 2002-167548

Patent Document 4: Japanese Unexamined Patent Application Publication No. 2003-64301

Patent Document 5: Japanese Unexamined Patent Application Publication No. 2003-49113

Patent Document 6: Japanese Unexamined Patent Application Publication No. 2009-149791

Patent Document 7: WO2007/102587

Patent Document 8: Japanese Unexamined Patent Application Publication No. H-09-20878

Patent Document 9: Japanese Unexamined Patent Application Publication No. 2011-111490

Patent Document 10: Japanese Unexamined Patent Application Publication No. 2011-21157

### SUMMARY OF INVENTION

### Technical Problems

Thus, conventional room temperature-curable coating compositions had a problem in that the environmental burden is high due to the inclusion of a large amount of organic solvent. Additionally, with existing water-based coating compositions or solvent-free coating compositions, there are problems in that weatherability of the cured film is low, and cracking is caused by the produced low-boiling components.

The present invention was developed to solve the problems described above. An object of the present invention is to provide a room temperature-curable coating composition that has superior weatherability, in which cracking over time is suppressed due to by-products not being produced when curing, and the environmental burden is poor due to an organic solvent not being included.

### Solution to Problems

As a result of diligent studies in order to achieve the aforementioned objectives, the inventors of the present invention have completed the present invention. Specifically, the objects of the present invention are achieved by:

a room temperature-curable coating composition comprising: (A) an epoxy-functional organopolysiloxane and

(B) an amino-functional organopolysiloxane.

The component (A) preferably has a branched or reticular molecular structure.

The component (A) preferably is liquid at 25° C.

The component (A) preferably has at least two epoxy-functional groups in one molecule.

An epoxy equivalent weight of the component (A) is preferably from 150 to 2,000 and more preferably from 150 to 1,500.

The component (B) preferably has a branched or reticular molecular structure.

The component (B) preferably is liquid at 25° C.

An amino equivalent weight of the component (B) is preferably from 80 to 2,000 and is more preferably from 150 to 1,500.

The amino-functional group of the component (B) is not particularly limited, but is preferably an amino-functional group represented by the formula:

—R¹—(NR²CH₂CH₂)ₐ—NR³—R⁴

(wherein a is an integer not less than 0; R¹ is a divalent hydrocarbon group; R², R³, and R⁴ are hydrogen atoms, monovalent hydrocarbon groups, acyl groups, or —CH₂CH(OH)R⁵ (wherein R⁵ is a monovalent organic group); and at least one of R², R³, and R⁴ is a hydrogen atom). Additionally, R³ and R⁴ are preferably hydrogen atoms.

A ratio of the epoxy-functional groups of the component (A) to the amino-functional groups of the component (B) is preferably from 0.5 to 2.0.

### Advantageous Effects of Invention

According to the present invention, a room temperature-curable coating composition can be provided by which environmental burden is low due to an organic solvent not being included, by-products are not produced when curing, and a cured film having superior weatherability can be obtained.

With the room temperature-curable coating composition of the present invention, by-products are not produced when curing and, therefore, cracking in the cured film can be suppressed.

### DESCRIPTION OF EMBODIMENTS

A room temperature-curable coating composition of the present invention comprises:

(A) an epoxy-functional organopolysiloxane and

(B) an amino-functional organopolysiloxane.

The molecular structure of the component (A) is not particularly limited, but is preferably a branched or reticular molecular structure having a straight difunctional siloxane unit represented by R₂SiO_{2/2} (where R is a hydrogen atom or a monovalent hydrocarbon group), and a trifunctional siloxane unit represented by RSiO_{3/2} or a tetrafunctional siloxane unit represented by SiO_{4/2} in the molecule. Because the component (A) has a branched or reticular molecular structure, curability of the coating composition of the present invention is superior and sufficient hardness and strength can be imparted to an obtained coating film.

The component (A) may comprise a monofunctional siloxane unit represented by R₃SiO_{1/2}.

The component (A) may be a single type of organopolysiloxane or may be a mixture of two or more types of organopolysiloxanes. Examples thereof include a mixture of a straight or cyclic organopolysiloxane comprising from 2 to 10 difunctional siloxane units represented by R₂SiO_{2/2} and an organopolysiloxane having a branched or reticular molecular structure that has a difunctional siloxane units represented by R₂SiO_{2/2}, a trifunctional siloxane unit represented by RSiO_{3/2} or a tetrafunctional siloxane unit represented by SiO_{4/2} in the molecule.

The room temperature-curable coating composition of the present invention can be configured as a solvent-free coating composition in which an organic solvent is not compounded. In this case, from the perspective of handleability and the like, the component (A) is preferably liquid at 25° C.

The component (A) preferably has at least two epoxy-functional groups in one molecule. The epoxy-functional groups react with amino-functional groups of an amino-functional organopolysiloxane (described below) so as to cure the room temperature-curable coating composition of the present invention. In cases where at least two epoxy-functional groups are present in one molecule, there is a tendency for advantageous curability to be imparted to the composition.

An epoxy equivalent weight of the component (A) is preferably from 150 to 2,000 and more preferably from 150 to 1,500. The epoxy equivalent weight in the present invention is measured by titrimetry and, preferably, can be measured in accordance with JIS K 7236. When the epoxy equivalent weight is within the range described above, the curability of the coating composition of the present invention will be excellent, and the mechanical strength, flexibility, and adhesion of the cured product will tend to be superior.

The epoxy-functional groups of the component (A) are functional groups having at least one epoxy group. The epoxy group is not particularly limited and examples thereof include a glycidyl group; a glycidoxy group; a 3,4-epoxybutyl group; a 4,5-epoxypentyl group; an epoxycyclohexyl group; a 2-glycidoxyethyl group, a 3-glycidoxypropyl group, a 4-glycidoxybutyl group, or similar glycidoxyalkyl group; a 2-(3,4-epoxycyclohexyl)ethyl group, a 3-(3,4-epoxycyclohexyl)propyl group, or similar 3,4-epoxycyclohexylalkyl group; and a 4-oxiranylbutyl group, an 8-oxiranyloctyl group, or similar oxiranylalkyl group. Of these, from the perspective of ease of aquisition of a raw material intermediate, a glycidoxyalkyl group or a 3,4-epoxycyclohexylalkyl group is preferable. The glycidoxyalkyl group preferably has from 4 to 10 carbons, and the 3,4-epoxycyclohexylalkyl group preferably has from 8 to 16 carbons.

Examples of silicon-bonded organic groups other than the epoxy-functional groups in the component (A) include methyl groups, ethyl groups, propyl groups, butyl groups, pentyl groups, hexyl groups, octyl groups, decyl groups, dodecyl groups, and similar alkyl groups; phenyl groups, tolyl groups, and similar aryl groups; β-phenylethyl groups and similar aralkyl groups; vinyl groups, allyl groups, propenyl groups, hexenyl groups, and similar alkenyl groups; 3,3,3-trifluoropropyl groups, 3-chloropropyl groups, and similar halogen substituted alkyl groups; and the like. Additionally, the component (A) may comprise a small amount of silicon-bonded hydrogen atoms, hydroxyl groups, or alkoxy groups.

The molecular structure of the component (B) is not particularly limited, but is preferably a branched or reticular molecular structure having a straight difunctional siloxane unit represented by R₂SiO_{2/2} (where R is a hydrogen atom or a monovalent hydrocarbon group), and a trifunctional siloxane unit represented by RSiO_{3/2} or a tetrafunctional siloxane unit represented by SiO_{4/2} in the molecule. Because the component (B) has a branched or reticular molecular structure, curability of the coating composition of the present invention is superior and sufficient hardness and strength can be imparted to an obtained coating film.

The component (B) may comprise a monofunctional siloxane unit represented by R₃SiO_{1/2}.

The component (B) may be a single type of organopolysiloxane or may be a mixture of two or more types of organopolysiloxanes. Examples thereof include a mixture of a straight or cyclic organopolysiloxane comprising from 2 to 10 difunctional siloxane units represented by R₂SiO_{2/2} and an organopolysiloxane having a branched or reticular molecular structure that has a difunctional siloxane units represented by R₂SiO_{2/2}, a trifunctional siloxane unit represented by RSiO_{3/2} or a tetrafunctional siloxane unit represented by SiO_{4/2} in the molecule.

The room temperature-curable coating composition of the present invention can be configured as a solvent-free coating composition in which an organic solvent is not compounded. In this case, from the perspective of handleability and the like, the component (B) is preferably liquid at 25° C.

The component (B) has at least two nitrogen-bonded hydrogen atoms derived from amino-functional groups in one molecule. The amino-functional groups of the component (B) react with the epoxy-functional groups of the epoxy-functional organopolysiloxane described above so as to cure the room temperature-curable coating composition of the present invention.

In cases where the amino-functional groups in the component (B) are secondary amines, preferably at least two amino-functional groups are present in one molecule. Note that from the perspective of the curability of the room temperature-curable coating composition of the present invention, the component (B) preferably has at least two amino-functional groups, which have a primary amine, in one molecule.

An amino equivalent weight of the component (B) is preferably from 80 to 2,000 and more preferably from 150 to 1,500. The amino equivalent weight in the present invention is a value calculated based on an amino value measured via potentiometric titration of a sample dissolved in chloroform with a 0.01 N perchloric acid solution as groups, and can be preferably measured in accordance with JIS K 2501. When the amino equivalent weight is within the range described above, the curability of the coating composition of the present invention will be excellent, and the mechanical strength, flexibility, and adhesion of the cured product will tend to be superior.

The amino-functional groups of the component (B) are functional groups having at least one amino group in one molecule. The amino-functional group is not particularly limited, but is preferably an amino-functional group represented by the formula:

—R¹—(NR²CH₂CH₂)ₐ—NR³—R⁴

(wherein a is an integer not less than 0; R¹ is a divalent hydrocarbon group; R², R³, and R⁴ are hydrogen atoms, monovalent hydrocarbon groups, acyl groups, or —CH₂CH(OH)R⁵ (wherein R⁵ is a monovalent organic group); and at least one of R², R³, and R⁴ is a hydrogen atom).

The divalent hydrocarbon group in the formula (the R¹ moiety) is not particularly limited, and examples thereof include methylene groups, dimethylene groups, trimethylene groups, tetramethylene groups, pentamethylene groups, hexamethylene groups, heptamethylene groups, octamethylene groups, and similar straight or branched alkylene groups having from 1 to 8 carbons; vinylene groups, allylene groups, butenylene groups, hexenylene groups, octenylene groups, and similar alkenylene groups having from 2 to 8 carbons; phenylene groups and similar arylene groups having from 6 to 8 carbons; dimethylenephenylene groups and similar alkylene-arylene groups having from 7 to 8 carbons; and groups wherein the hydrogen atoms bonded to the carbon atoms of these groups are substituted at least partially by fluorine or a similar halogen atom, or an organic group having a carbinol group, an epoxy group, a glycidyl group, an acyl group, a carboxyl group, an amino group, a (meth)acryl group, a mercapto group, an amide group, an oxyalkylene group, or the like. The divalent hydrocarbon groups are preferably alkylene groups having from 1 to 8 carbons, more preferably are alkylene groups having from 1 to 6 carbons, and even more preferably alkylene groups having from 3 to 5 carbons.

The R², R³, and R⁴ monovalent hydrocarbon group moieties are not particularly limited, and examples thereof include methyl groups, ethyl groups, propyl groups, butyl groups, pentyl groups, hexyl groups, heptyl groups, octyl groups, and similar alkyl groups; cyclopentyl groups, cyclohexyl groups, and similar cycloalkyl groups; vinyl groups, allyl groups, butenyl groups, and similar alkenyl groups; phenyl groups, tolyl groups, and similar aryl groups; benzyl groups and similar aralkyl groups; and groups wherein the hydrogen atoms bonded to the carbon atoms of these groups are substituted at least partially by fluorine or a similar halogen atom, or an epoxy group, a glycidyl group, an acyl group, a carboxyl group, an amino group, a methacryl group, a mercapto group, or a similar organic group. The monovalent hydrocarbon groups preferably have from 1 to 8 carbons. The R³ and R⁴ moieties are preferably hydrogen atoms.

The R⁵ monovalent organic group moiety in the formula is not particularly limited, but preferably is a substituted or unsubstituted monovalent hydrocarbon group, a (meth)acryl group, an amide group, a carbinol group, or a phenol group. Examples of the substituted or unsubstituted monovalent hydrocarbon group include the groups described as examples for the R², R³, and R⁴ monovalent hydrocarbon group moieties.

Examples of silicon-bonded organic groups other than the amino-functional groups in the component (B) include methyl groups, ethyl groups, propyl groups, butyl groups, pentyl groups, hexyl groups, octyl groups, decyl groups, dodecyl groups, and similar alkyl groups; phenyl groups, tolyl groups, and similar aryl groups; β-phenylethyl groups and similar aralkyl groups; vinyl groups, allyl groups, propenyl groups, hexenyl groups, and similar alkenyl groups; 3,3,3-trifluoropropyl groups, 3-chloropropyl groups, and similar halogen substituted alkyl groups; and the like. Additionally, the component (B) may comprise a small amount of silicon-bonded hydrogen atoms, hydroxyl groups, or alkoxy groups.

The ratio of the epoxy-functional groups of the component (A) to the amino-functional groups of the component (B) is preferably from 0.5 to 2.0. When the ratio of the epoxy-functional groups to the amino-functional groups is within the range described above, the curability of the coating composition of the present invention will be excellent, and the mechanical strength, flexibility, and adhesion of the cured product will tend to be superior.

The room temperature-curable coating composition of the present invention may comprise other optional additives so long as the object of the present invention is not inhibited. Examples of these additives include pigments, inorganic fillers, diluents, rust inhibitors, and the like that are commonly compounded in coating compositions. Types and compounded amounts of the additives can be appropriately adjusted depending on the use of the room temperature-curable coating composition of the present invention.

Examples of pigments that can be added to the room temperature-curable coating composition of the present invention include titanium oxide, ultramarine blue, Prussian blue, zinc oxide, red iron oxide, chrome yellow, lead white, carbon black, iron oxide, aluminum powder, and similar inorganic pigments; and azo pigments, triphenylmethane pigments, quinoline pigments, anthoraquinone pigments, phthalocyanine pigments, and similar organic pigments.

Examples of inorganic fillers that can be added to the room temperature-curable coating composition of the present invention include dry method silica, wet method silica, fine quartz powder, titanium dioxide powder, diatomaceous earth powder, aluminum hydroxide powder, fine alumina powder, magnesia powder, zinc oxide powder, talc, mica, and the aforementioned products that are surface coated with silanes, silazanes, low-degree-polymerization polysiloxanes, or other finely powdered inorganic fillers.

The room temperature-curable coating composition of the present invention does not require a curing catalyst, but may comprise a tin compound or the like as a curing catalyst for the purpose of accelerating the curing of the coating film.

In cases where the components (A) and (B) of the present invention are liquid at room temperature, it is not necessary to compound a solvent, but, depending on needs that arise due to the coating method or the like, ligroin or a similar non-aromatic hydrocarbon solvent, or methanol, ethanol, isopropanol, methyl ethyl ketone, ethyl acetate, or a similar known solvent can be compounded. Additionally, as necessary, the components (A) and (B) may be emulsified in water in the presence of a surfactant and used.

The room temperature-curable coating composition of the present invention can be used as a coating of any type of substrate. The substrate is not particularly limited and various types of inorganic substrates and organic substrates, or combinations thereof can be used. Examples of inorganic substrates include substrates formed from aluminum or a similar metal. Examples of organic substrates include substrates formed from organic resins, wood, paper, or similar substances. More specific examples of the organic resins include fluoro resins, acrylic resins, polyethylenes, polypropylenes, polycarbonates, polyacrylates, polyesters, polyamides, polyurethanes, ABS resins, polyvinyl chlorides, silicones, acrylic silicones, and similar modified silicones. Among these, silicones, modified silicones, polyvinyl chloride, fluoro resins, polycarbonates, and acrylic polymers are preferable. The form of the substrate is not particularly limited and can be any shape desired such as cubic, rectangular solid, spherical, sheet-like, and the like. Note that the substrate may also be porous.

The room temperature-curable coating composition of the present invention can be applied on a substrate via a conventionally known process such as, for example, immersing, spraying, brush application, blade coating, and the like. One coat may be applied or a plurality of coats may be applied on top of each other. After the application, the coating film can be obtained by allowing the applied coating to rest as-is and cure under heated or room temperature conditions, preferably under room temperature conditions. A thickness of the coating film can be set as desired, but is preferably from 1 to 500 μm.

### EXAMPLES

Hereinafter, examples will be used to describe the present invention in more detail. In the examples, the content of the components referred to as “parts” means “parts by weight.” Note that the present invention is not limited to these examples.

### Synthesis Example 1

### Preparation of Phenyltrichlorosilane Hydrolysis Condensation Product

250 g of water and 400 g of toluene were placed in a 2,000 mL flask provided with a thermometer and a refluxing cooler. Then, a mixture of 300 g of phenyltrichlorosilane and 200 g of toluene was added dropwise at a temperature adjusted to 10° C. After the adding was completed, the mixture was heated to reflux for six hours and, thereafter, the toluene solution was separated. The toluene solution was subjected to repeated aqueous washing using 300 g of water until the wash liquid became neutral. Thereafter, the toluene was removed by distillation by heating the toluene solution under reduced pressure. Thus 177.7 g of a white solid phenyltrichlorosilane hydrolysis condensation product was obtained.

### Synthesis of the Epoxy-Functional Organopolysiloxane

371 g of the phenyltrichlorosilane hydrolysis condensation product obtained as described above (molecular weight: 1,000, silanol group content: 8.0 wt. %), 577 g of glycidoxypropyl methyldimethoxysilane, 564 g of octamethylcyclotetrasiloxane, and 927 g of toluene were placed in a reaction vessel provided with an agitator, a thermometer, a reflux tube, and a dropping funnel, heated to 50° C., and agitated. A mixture of 2.3 g of cesium hydroxide and 47.1 g of water was gradually added to the reaction vessel using a dropping funnel. After the adding was completed, the mixture was refluxed for one hour. Methanol that was produced and excess water was removed via azeotropic dehydration and then the resulting product was reacted for eight hours in toluene at reflux. After cooling, the product was neutralized using acetic acid, and the toluene and low-boiling components were heated and removed by distillation under reduced pressure. Then the neutralization salt was filtered. Thus, a 600 mPa·s, tan, transparent liquid was obtained. This liquid had a weight average molecular weight of 6,000 and an epoxy group content of 510 g/mol and it was confirmed via ¹³C-nuclear magnetic resonance spectroscopic analysis that the liquid was a 3-glycidoxypropyl group-containing siloxane compound represented by the structural formula: (Me₂SiO_{2/2})_{0.57}(EpMeSiO_{2/2})_{0.21}(PhSiO_{3/2})_{0.22} (where “Me” represents a methyl group, “Ep” represents a glycidoxypropyl group, and “Ph” represents a phenyl group). Content of hydroxyl groups or methoxy groups and similar alkoxy groups was less than 1 wt. %.

### Synthesis Example 2

### Synthesis of the Epoxy-Functional Organopolysiloxane

341 g of the phenyltrichlorosilane hydrolysis condensation product obtained as described above (molecular weight: 1,000, silanol group content: 8.0 wt. %), 528 g of glycidoxypropyl methyldimethoxysilane, 517 g of a polydimethyl siloxane having trimethylsilyl terminals and a kinetic viscosity at 25° C. of 5 mm²/s, and 183 g of toluene were placed in a reaction vessel provided with an agitator, a thermometer, a reflux tube, and a dropping funnel, heated to 50° C., and agitated. A mixture of 2.5 g of cesium hydroxide and 43.2 g of water was gradually added to the reaction vessel using a dropping funnel. After the adding was completed, the mixture was refluxed for one hour. Produced methanol and excess water were removed via azeotropic dehydration and then the resulting product was reacted for eight hours in toluene at reflux. After cooling, the product was neutralized using acetic acid, and the toluene and low-boiling components were heated and removed by distillation under reduced pressure. Then the neutralization salt was filtered. Thus, a 270 mPa·s, tan, transparent liquid was obtained. This liquid had a weight average molecular weight of 4,100 and an epoxy group content of 530 g/mol and it was confirmed via ¹³C-nuclear magnetic resonance spectroscopic analysis that the liquid was a 3-glycidoxypropyl group-containing siloxane compound represented by the structural formula: (Me₃SiO_{1/2})_{0.12}(Me₂SiO_{2/2})_{0.44}(EpMeSiO_{2/2})_{0.20}(PhSiO_{3/2})_{0.22} (where “Me” represents a methyl group, “Ep” represents a glycidoxypropyl group, and “Ph” represents a phenyl group). Content of hydroxyl groups or methoxy groups and similar alkoxy groups was less than 1 wt. %.

### Synthesis Example 3

### Synthesis of the Amino-Functional Organopolysiloxane

388 g of the phenyltrichlorosilane hydrolysis condensation product obtained as described above (molecular weight: 1,000, silanol group content: 8.0 wt. %), 352 g of a hydrolysate of aminopropylmethyldimethoxysilane, 466 g of decamethyltetrasiloxane, and 388 g of toluene were placed in a reaction vessel provided with an agitator, a thermometer, a reflux tube, and a dropping funnel, heated to 50° C., and agitated. 0.72 g of 11 N potassium hydroxide was added and the mixture was heated. After refluxing for one hour, produced water was removed via azeotropic dehydration and then the resulting product was reacted for eight hours in toluene at reflux. After cooling, 0.72 g of acetic acid was added to neutralize the mixture. The toluene and low-boiling components were removed by distillation under reduced pressure and, thereafter the neutralization salt was filtered. Thus, a 300 mPa·s, colorless, transparent liquid was obtained. This liquid had a weight average molecular weight of 3,500 and an amino group content of 380 g/mol and it was confirmed via ¹³C-nuclear magnetic resonance spectroscopic analysis that the liquid was a 3-aminopropyl group-containing siloxane compound represented by the structural formula: (Me₃SiO_{1/2})_{0.21}((Me₂SiO_{2/2})_{0.26}(AmMeSiO_{2/2})_{0.27}(PhSiO_{3/2})_{0.26} (where “Me” represents a methyl group, “Am” represents an aminopropyl group, and “Ph” represents a phenyl group). Content of hydroxyl groups or methoxy groups and similar alkoxy groups was less than 1 wt. %.

### Viscosity Measurement

Viscosity at 25° C. was measured using a rotational viscometer VG-DA (manufactured by Shibaura System Co., Ltd.).

### Preparation Example 1

4 parts of a pigment (CRENOX, manufactured by LANXESS) were dispersed in 96 parts of the epoxy-functional organopolysiloxane obtained in Synthesis Example 1 using a high-speed disperser (Dispermat®). Thus, a white epoxy resin base was obtained.

### Preparation Example 2

4 parts of a pigment (CRENOX, manufactured by LANXESS) were dispersed in 96 parts of the epoxy-functional organopolysiloxane obtained in Synthesis Example 2 using a high-speed disperser (Dispermat®). Thus, a white epoxy resin base was obtained.

### Preparation Example 3

4 parts of a pigment (CRENOX, manufactured by LANXESS) were dispersed in 96 parts of the amino-functional organopolysiloxane obtained in Synthesis Example 3 using a high-speed disperser (Dispermat®). Thus, a white amino resin base was obtained.

### Practical Example 1

The epoxy resin base of Preparation Example 1 and the amino resin base of Preparation Example 3 were mixed such that the amino groups and the epoxy groups were at a 1:1 equivalent weight. Thus, a solvent-free coating composition was prepared.

### Practical Example 2

The epoxy resin base of Preparation Example 2 and the amino resin base of Preparation Example 3 were mixed such that the amino groups and the epoxy groups were at a 1:1 equivalent weight. Thus, a solvent-free coating composition was prepared.

### Comparative Example 1

4 parts of a pigment (CRENOX, manufactured by LANXESS), 2 parts of a crosslinking agent (SH6020, manufactured by Dow Corning Toray Co., Ltd.), and 3 parts of a curing catalyst (NEOSTANN U-200, manufactured by Nitto Kasei Co., Ltd.) were dispersed in 96 parts of a methoxy-functional phenyl silicone resin using a high-speed disperser (Dispermat®). Thus, a white condensation coating composition was obtained.

### Comparative Example 2

Muki Fusso (manufactured by Kansai Paint Co., Ltd.) was mixed as a base resin with a curing agent at a ratio of 14/1. Then, 10 parts of a solvent was added and the mixture was uniformly mixed. Thus, a white coating composition having a solvent-based fluoro resin base was obtained.

### Formation of the Coating Film

The coating composition prepared as described above was applied to an SUS or aluminum panel using a 6 mil applicator. After drying/curing at room temperature for seven days, a coating film was obtained.

### Evaluation Method of Cracking

The fabricated panels were placed in a weather-ometer tester, a heat cycle tester, and a super UV tester and the state of cracking was visually observed after a predetermined period of time.

### Evaluation conditions

### Weather-Ometer

A Xenon Arc Weather-ometer Ci 4000 (manufactured by Toyo Seiki Seisaku-sho, Ltd.) was used. Evaluation conditions are shown in the table below.

TABLE 1

| | |
|---|---|
| Irradiance (340 nm) | 0.51 ± 0.02 W/m² |
| Black panel | 63 ± 3° C. |
| temperature | |
| Temperature in the | 38 ± 3° C. |
| tester | |
| Humidity | 50 ± 10% RH |
| Cycle | 102 minute irradiation followed by 18 minute spray |
| | (sprayed with pure water)→repeat thereafter |

### Heat Cycle Test

An LH43 (manufactured by Nagano Science Co., Ltd) was used. Evaluation was conducted under the following conditions.

−40° C.×10 min. →(80 min.)→90° C.×10 min.→(80 min.)→(−40° C.)

### Super UV Test

An SUV-W151 (manufactured by Iwasaki Electric Co., Ltd.) was used. Evaluation conditions are shown in the table below

TABLE 2

| | | |
|---|---|---|
| When irradiating | Black panel temperature | 63° C. |
| | Humidity | 50% RH |
| | Illuminance | 100 mW/cm² |
| | Time | 10 hours |
| When condensing | Black panel temperature | 25° C. |
| | Humidity | 95% RH |
| | Time | 2 hours |

| | |
|---|---|
| Shower | When irradiating: |
| | 10 sec./1 hour |

### Evaluation results

### Weather-Ometer Test

TABLE 3

| | Exposure | Practical | Practical | Comparative | Comparative |
|---|---|---|---|---|---|
| | Time | Example 1 | Example 2 | Example 1 | Example 2 |
| Color | 1140 h | 0.99 | 0.78 | 3.22 | 2.38 |
| Differ- | 2020 h | 0.81 | 0.67 | 3.30 | 2.57 |
| ence | 3048 h | 0.81 | | 3.36 | 2.80 |
| (ΔE) | | | | | |

### Heat Cycle Test

TABLE 4

| Number | Practical | Practical | Comparative | Comparative |
|---|---|---|---|---|
| of Cycles | Example 1 | Example 2 | Example 1 | Example 2 |
| 100 | No cracking | No cracking | No cracking | No cracking |
| 150 | No cracking | No cracking | Cracking | No cracking |
| | | | occurred | |
| 1000 | No cracking | | | No cracking |

### Super UV Test

TABLE 5

| | Practical | Practical | | Compar- |
|---|---|---|---|---|
| Exposure | Example | Example | Comparative | ative |
| Time | 1 | 2 | Example 1 | Example 2 |
| 1 week | No | No | No | No |
| (168 h) | change | change | change | change |
| 2 weeks | No | No | 15% cracking of the | No |
| (336 h) | change | change | coated surface and | change |
| | | | floating of the coating | |
| | | | film was observed. | |
| 3 weeks | No | No | 20% cracking of the | No |
| (504 h) | change | change | coated surface or | change |
| | | | peeling/separation of | |
| | | | the coating film was | |
| | | | observed. | |
| 4 weeks | No | No | 30% cracking of the | No |
| (672 h) | change | change | coated surface or | change |
| | | | peeling/separation of | |
| | | | the coating film was | |
| | | | observed. | |
| 5 weeks | No | No | 80% peeling/separation | No |
| (840 h) | change | change | of the coating film in | change |
| | | | the coated surface | |
| | | | was observed. | |

Table 3 shows results of the weather-ometer test. As it is clear from Table 3, in cases where the coating compositions of Practical Example 1 and Practical Example 2 were used, color difference (LE) was extremely low. On the other hand, it is clear that when Comparative Examples 1 and 2 were used, the color difference was great, and the change thereof increases with the passage of exposure time.

Additionally, Table 4 shows results of the heat cycle test. In cases where the coating composition of Comparative Example 1 was used, cracking occurred within 100 to 150 cycles, but in cases where the coating compositions of Practical Example 1 and Practical Example 2 were used, cracking did not occur.

Furthermore, Table 5 shows results of the super UV test. In cases where the coating compositions of Practical Example 1 and Practical Example 2 were used, there was no change even after 6 weeks (1008 h) had passed. However in cases where the coating composition of Comparative Example 1 was used, 15% cracking in the coated surface and floating of the coating film was observed after 2 weeks (336 h) had passed. Moreover, in the coated surface, 80% peeling/separation of the coating film were observed after 5 weeks (840 h) had passed.

1. A room temperature-curable coating composition comprising:
(A) an epoxy-functional organopolysiloxane; and
(B) an amino-functional organopolysiloxane.

2. The room temperature-curable coating composition according to claim 1, wherein component (A) has a branched or reticular molecular structure.

3. The room temperature-curable coating composition according to claim 1, wherein component (A) is liquid at 25° C.

4. The room temperature-curable coating composition according to claim 1, wherein component (A) has at least two epoxy-functional groups in one molecule.

5. The room temperature-curable coating composition according to claim 1, wherein an epoxy equivalent weight of component (A) is from 150 to 2,000.

6. The room temperature-curable coating composition according to claim 5, wherein the epoxy equivalent weight of component (A) is from 150 to 1,500.

7. The room temperature-curable coating composition according to claim 1, wherein component (B) is a branched or reticular molecular structure.

8. The room temperature-curable coating composition according to claim 1, wherein component (B) is liquid at 25° C.

9. The room temperature-curable coating composition according to claim 1, wherein an amino equivalent weight of component (B) is from 80 to 2,000.

10. The room temperature-curable coating composition according to claim 9, wherein the amino equivalent weight of component (B) is from 150 to 1,500.

11. The room temperature-curable coating composition according to claim 1, wherein component (B) has an amino-functional group represented by the formula:
—R¹—(NR²CH₂CH₂)ₐ—NR³—R⁴
wherein a is an integer not less than 0; R¹ is a divalent hydrocarbon group; R², R³, and R⁴ are hydrogen atoms, monovalent hydrocarbon groups, acyl groups, or —CH₂CH(OH)R⁵ wherein R⁵ is a monovalent organic group; and at least one of R², R³, and R⁴ is a hydrogen atom.

12. The room temperature-curable coating composition according to claim 11, wherein R³ and R⁴ are hydrogen atoms.

13. The room temperature-curable coating composition according to claim 1, wherein a ratio of the epoxy groups of component (A) to the amino groups of component (B) is from 0.5 to 2.0.

14. The room temperature-curable coating composition according to claim 1, which is free of organic solvent.
